(19) United States
(12) Patent Application Publication
(10) Pub. No.: US 2021/0050151 A1
(43) Pub. Date: Feb. 18, 2021

(54) JIG FOR WIRELESS CHARGING COIL WINDING MACHINE

(71) Applicant: Jabil Circuit (Singapore) Pte. Ltd., Singapore (SG)

(72) Inventors: Yoshio Kouda, Wuxi (CN); Kai-En Huang, Wuxi (CN)

(73) Assignee: Jabil Circuit (Singapore) Pte. Ltd., Singapore (SG)

(21) Appl. No.: 16/991,163

(22) Filed: Aug. 12, 2020

(30) Foreign Application Priority Data
Aug. 15, 2019 (CN) 201921331457.5

(51) Int. Cl. H01F 41/06; H01F 38/14; H01F 27/08; H01F 27/28

(52) U.S. Cl. CPC H01F 41/06; H01F 27/2876; H01F 27/085; H01F 38/14

(57) ABSTRACT

A jig adapted for use in a wireless charging coil winding machine has a base portion and a main portion. The main portion is made of a heat-conductive material, and has an end surface, a plurality of passage-defining members, and a connecting member. The passage-defining members are made by three-dimensional printing, and define a plurality of air passages. The connecting member is formed with a plurality of air slots. During operation of the wireless charging coil winding machine, air is supplied into the air passages, and flows out of the jig through the air slots for facilitating heat transfer between the end surface and a wireless charging coil.

### CROSS-REFERENCE TO RELATED APPLICATION

This application claims priority of Chinese Patent Application No. 201921331457.5, filed on Aug. 15, 2019.

### FIELD

The disclosure relates to a wireless charging coil machine, and more particularly to a jig for use in a wireless charging coil machine.

### BACKGROUND

For a wireless charging coil winding machine, a winding operation of a wireless charging coil typically includes three processes: heating, where a wireless charging wire is heated by a heating system to a predetermined temperature; coil winding, where the wireless charging wire is wound into a coil and self-bonded by heat; and cooling, where the wireless charging coil is cooled down by a cooling system.

Referring to FIG. 1, during the winding operation, two conventional jigs 100 are respectively mounted to two spindles 200 of the wireless charging coil winding machine for clamping the wireless charging wire 300 therebetween. A cycle time of the winding operation using such conventional jigs 100 is around 50 seconds in total, which includes 22 seconds of heating, 6 seconds of coil winding, and 22 seconds of cooling. Evidently, the heating and cooling processes take up most of the cycle time.

### SUMMARY

Therefore, the object of the disclosure is to provide a jig for use in a wireless charging coil machine that has relatively short heating and cooling processes.

According to the disclosure, a jig adapted for use in a wireless charging coil winding machine has a base portion and a main portion.

The base portion surrounds an axis and is adapted to be connected to the wireless charging coil winding machine.

The main portion is made of a heat-conductive material, extends from the base portion along the axis, and has an end wall, a plurality of passage-defining members, and a connecting member. The end wall is distal from the base portion along the axis, and has an end surface adapted for making contact with a wireless charging coil during operation of the wireless charging coil winding machine. The passage-defining members are connected to the end wall, are made by three-dimensional printing, and define a plurality of air passages. The connecting member is connected between the base portion and the passage-defining members, and is formed with a plurality of air slots. The air slots are arranged angularly around the axis and are in spatial communication with the air passages.

During operation of the wireless charging coil winding machine, air is supplied into the air passages, and flows out of the jig through the air slots for facilitating heat transfer between the end surface and the wireless charging coil.

### BRIEF DESCRIPTION OF THE DRAWINGS

Other features and advantages of the disclosure will become apparent in the following detailed description of the embodiments with reference to the accompanying drawings, of which:

FIG. 1 is a schematic perspective view illustrating two conventional jigs mounted respectively to two spindles of a wireless charging coil winding machine for clamping a wireless charging coil therebetween;

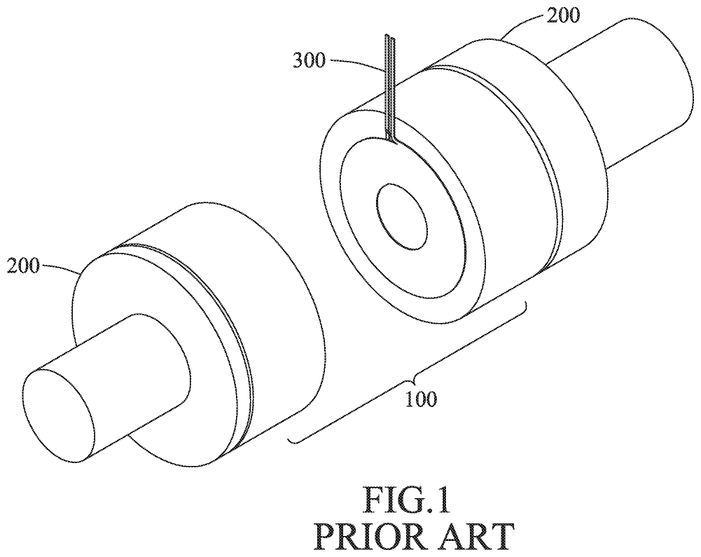

FIG. 2 is a perspective view of a first embodiment of a jig for use in a wireless charging coil winding machine according to the disclosure;

FIG. 3 is another perspective view of the first embodiment;

FIG. 4 is a side view of the first embodiment;

FIG. 5 is a perspective partly cutaway view of the first embodiment;

FIG. 6 is a perspective view of a second embodiment of a jig for use in a wireless charging coil winding machine according to the disclosure;

FIG. 7 is a perspective partly cutaway view taken along line XII-XII of FIG. 6; and

FIG. 8 is another perspective partly cutaway view taken along line XIII-XIII of FIG. 6.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

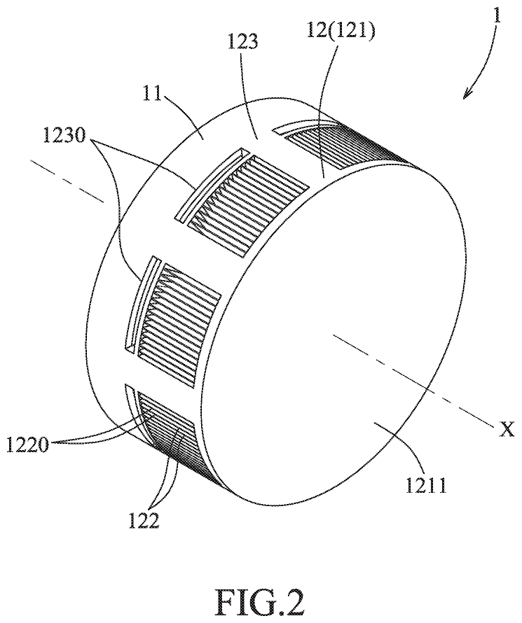

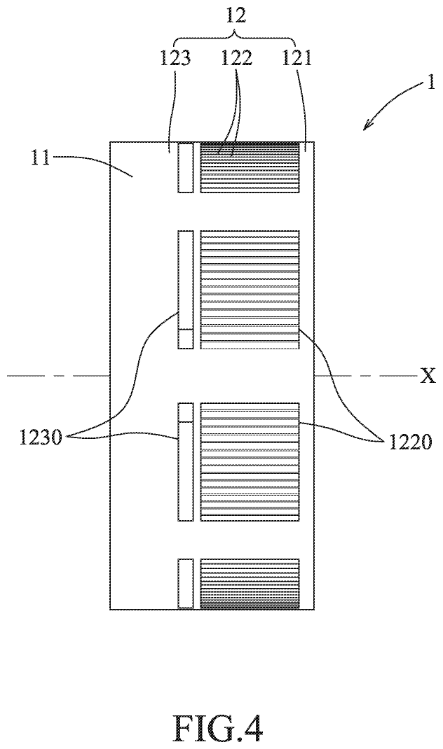

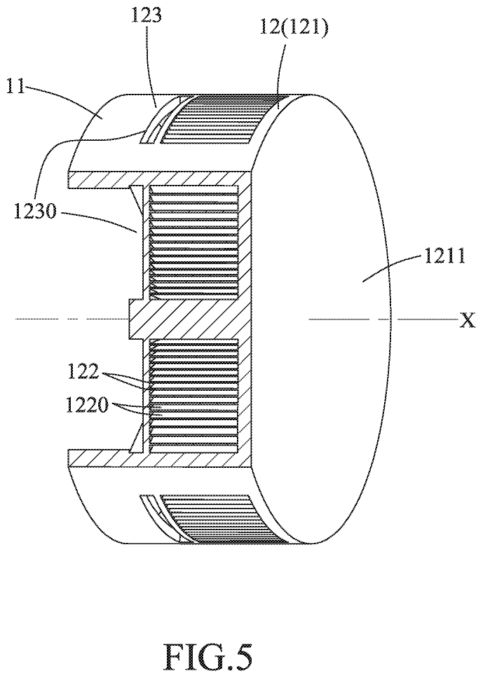

Referring to FIGS. 2 to 5, a first embodiment of a jig 1 according to the disclosure is adapted for use in a wireless charging coil winding machine (not shown). The jig 1 has a base portion 11 and a main portion 12.

The base portion 11 surrounds an axis (X) and is adapted to be connected to a spindle (not shown) of the wireless charging coil winding machine. The main portion 12 is made of a heat-conductive material, extends from the base portion 11 along the axis (X), and has an end wall 121, a plurality of passage-defining members 122, and a connecting member 123.

The end wall 121 is distal from the base portion 11 along the axis (X), and has an end surface 1211 adapted for making contact with a wireless charging coil during a winding operation of the wireless charging coil winding machine.

The passage-defining members 122 are connected to the end wall 121, are made by three-dimensional printing, and define a plurality of air passages 1220. In the present embodiment, the passage-defining members 122 are configured as fins for better heat dissipation, and are arranged angularly around the axis (X).

The connecting member 123 is connected between the base portion 11 and the passage-defining members 122, and is formed with a plurality of air slots 1230. The air slots 1230 are arranged angularly around the axis (X).

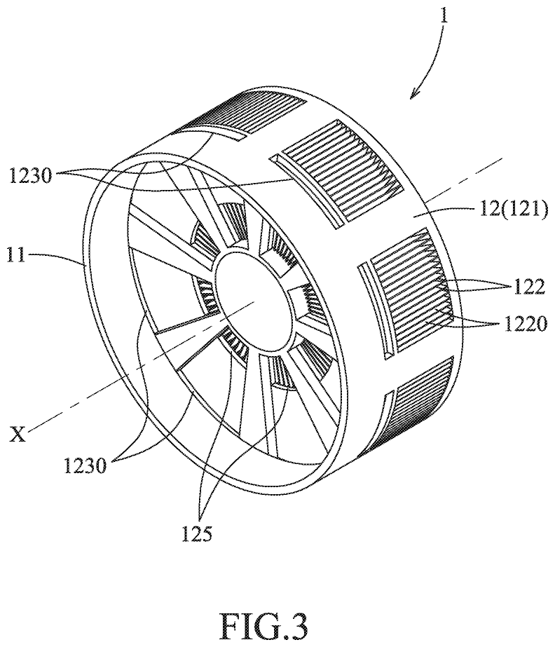

The connecting member 123 is further formed with a plurality of communication slots 125 (see FIG. 3) that communicate spatially the air passages 1220 with the air slots 1230, and that are angularly spaced-apart around the axis (X).

During the winding operation of the wireless charging coil winding machine, air is supplied into the air passages 1220, and flows out of the jig 1 through the air slots 1230 for facilitating heat transfer between the end surface 1211 and the wireless charging coil. More specifically, an annular shielding (not shown) is provided to surround and cover the air passages 1220. During a heating process or a cooling process of the winding operation, hot or cold air is supplied to fill a space between the annular shielding and the air passages 1220 and flows into all air passages 1220 before eventually flowing out of the jig 1 via the air slots 1230. In such a manner, uneven heating or cooling of the wireless charging coil is prevented.

Compared with the prior art, the jig 1 of the present embodiment has a greater heat-conducting surface area in virtue of the passage-defining members 122. In other words, there is more surface area to conduct heat transferred from the hot air to the jig 1 or from the jig 1 to the cold air. As a result, the heating and cooling processes of the winding operation become more efficient, thereby shortening a total cycle time of the winding operation.

It should be noted that, in the present embodiment, the main portion 12 is made by three-dimensional (3D) printing in a manner that the passage-defining members 122 are integrally formed in the main portion 12. However, in a variation of the present embodiment, the passage-defining members 122 may be made separately by 3D printing, and then mounted in the main portion 12. The passage-defining members 122 are made of materials such as copper or die steel.

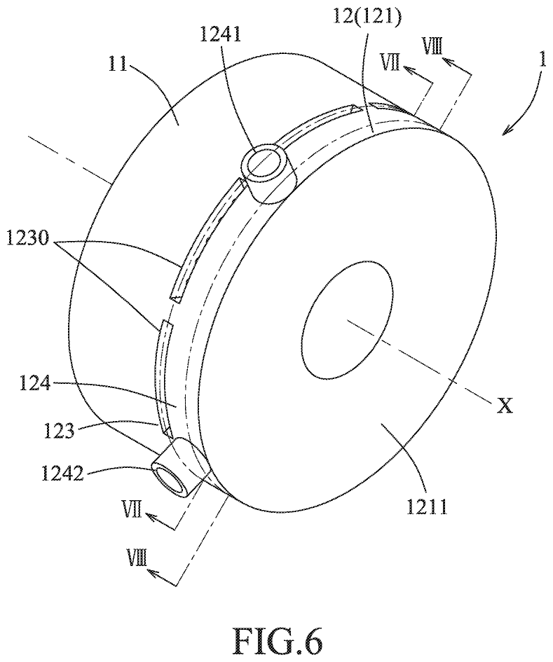

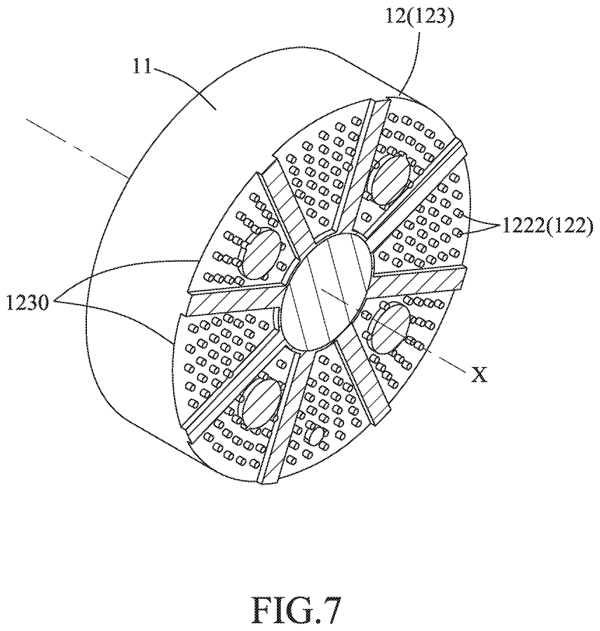

Referring to FIGS. 6 to 8, a second embodiment of the jig 1 according to the disclosure is similar to the first embodiment. The difference between the two embodiments resides in configuration of the main portion 12.

In the second embodiment, the main portion 12 further has an annular outer wall 124 surrounding the passage-defining members 122. The passage-defining members 122 includes a multilayer segment 1221 disposed within the outer wall 124, and a plurality of conducting poles 1222 extending parallel to the axis (X). Some of the conducting poles 1222 are distributed in the multilayer segment 1221 and cooperate with the multilayer segment 1221 to define the air passages 1220; the remainders of the conducting poles 1222 are distributed in the air slots 1230 of the connecting member 123.

The outer wall 124 is formed with a hot air inlet 1241 and a cold air inlet 1242 that are in spatial communication with the air passages 1220.

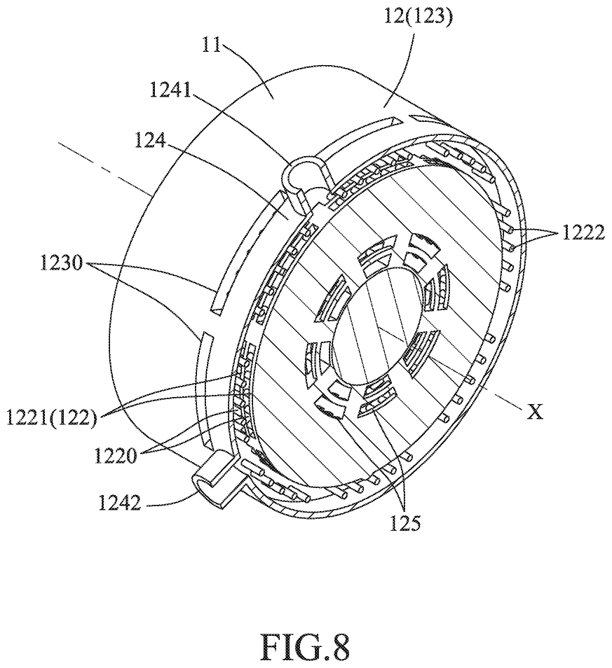

The communication slots 125 (see FIG. 8) are formed in the multilayer segment 1221, communicate spatially the air passages 1220 with the air slots 1230, and are angularly spaced-apart around the axis (X).

During the heating process of the winding operation, the hot air flows into the jig 1 through the hot air inlet 1241, flows through the air passages 1220, and flows out of the jig 1 through the air slots 1230. Similarly, during the cooling process of the winding operation, the cold air flows into the jig 1 through cold air inlet 1242, flows through the air passages 1220, and flows out of the jig 1 through the air slots 1230.

Similar to the first embodiment, the jig 1 of the present embodiment has a greater heat-conducting surface area than that of the prior art in virtue of the passage-defining members 122 having the conducting poles 1222, and thus, the total cycle time of the winding operation can be shortened by the present embodiment as well.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A jig adapted for use in a wireless charging coil winding machine, said jig comprising:
a base portion surrounding an axis and adapted to be connected to the wireless charging coil winding machine; and
a main portion made of a heat-conductive material, extending from said base portion along the axis, and having
an end wall that is distal from said base portion along the axis, and that has an end surface adapted for making contact with a wireless charging coil during operation of the wireless charging coil winding machine,
a plurality of passage-defining members that are connected to said end wall, that are made by three-dimensional printing, and that define a plurality of air passages, and
a connecting member that is connected between said base portion and said passage-defining members, and that is formed with a plurality of air slots being in spatial communication with said air passages;
wherein, during operation of the wireless charging coil winding machine, air is supplied into said air passages, and flows out of said jig through said air slots for facilitating heat transfer between said end surface and the wireless charging coil.

2. The jig as claimed in claim 1, wherein said air slots are arranged angularly around the axis.

3. The jig as claimed in claim 1, wherein said passage-defining members are configured as fins and are arranged angularly around the axis.

4. The jig as claimed in claim 1, wherein said passage-defining members of said main portion include a multilayer segment and a plurality of conducting poles, at least two of said conducting poles extending parallelly to the axis and distributed in said multilayer segment, said multilayer segment and said conducting poles cooperatively defining said air passages.

5. The jig as claimed in claim 4, wherein the remainders of said conducting poles extending parallel to the axis and distributed in said air slots of said connecting member.

6. The jig as claimed in claim 5, wherein said main portion further has an annular outer wall surrounding said passage-defining members, said outer wall being formed with a hot air inlet and a cold air inlet that are in spatial communication with said air passages.

7. The jig as claimed in claim 1, wherein said passage-defining members are disposed between in said end wall and said air slots along the axis.

8. The jig as claimed in claim 5, wherein said multilayer segment is formed with a plurality of communication slots that communicate spatially said air passages with said air slots.

9. The jig as claimed in claim 1, wherein said connecting member is further formed with a plurality of communication slots that communicates spatially said air passages with said air slots.

10. The jig as claimed in claim 9, wherein said communication slots are angularly spaced-apart around the axis.

11. A jig adapted for use in a wireless charging coil winding machine, said jig comprising:
a base portion adapted to be connected to the wireless charging coil winding machine; and
a main portion made of a heat-conductive material, and having
an end wall that has an end surface adapted for making contact with a wireless charging coil,
a plurality of fins that are made by three-dimensional printing, and that define a plurality of air passages, and
a plurality of air slots that are in spatial communication with said air passages.

12. The jig as claimed in claim 11, wherein said air slots are arranged angularly around the axis.

13. The jig as claimed in claim 11, wherein said air passages are angularly spaced-apart around the axis.

14. The jig as claimed in claim 13, wherein said fins are formed with a plurality of communication slots that communicate spatially said air passages with said air slots.

15. The jig as claimed in claim 14, wherein said communication slots are angularly spaced-apart around the axis.

16. A jig adapted for use in a wireless charging coil winding machine, and having one end adapted to be connected to the wireless charging coil winding machine, and an opposite end adapted for making contact with a wireless charging coil, said jig comprising:
a plurality of fins that are made by three-dimensional printing, that are angularly spaced-apart around an axis, and that define a plurality of air passages; and
a plurality of air slots that are in spatial communication with said air passages;
wherein, during operation of the wireless charging coil winding machine, air is supplied into said air passages, and flows out of said jig through said air slots.

17. The jig as claimed in claim 16, wherein said air slots are arranged angularly around a axis.

18. The jig as claimed in claim 16, wherein said air passages are angularly spaced-apart around the axis.

19. The jig as claimed in claim 16, wherein said fins are formed with a plurality of communication slots that communicate spatially said air passages with said air slots.

20. The jig as claimed in claim 19, wherein said communication slots are angularly spaced-apart around the axis.
